(19) United States
(12) Patent Application Publication
(10) Pub. No.: US 2010/0133196 A1
(43) Pub. Date: Jun. 3, 2010

(54) Combined gravity separation-filtration for conducting treatment processes in solid-liquid systems

(76) Inventor: Boris Mikhail Khudenko, Atlanta, GA (US)

Correspondence Address: BORIS M. KHUDENKO, 744 MOORES MILL ROAD, ATLANTA, GA, 30327, US

(21) Appl. No.: 12/454,070

(22) Filed: May 12, 2009

Related U.S. Application Data
(63) Continuation-in-part of application No. 11/893,872, filed on Aug. 18, 2007, now Pat. No. 7,553,418.

(51) Int. Cl. C02F 9/08; C02F 103/06; C02F 103/02; C02F 103/26; C02F 103/20; C02F 101/10; C02F 101/30

(52) U.S. Cl. 210/668; 210/790; 210/748.01; 210/695; 210/261

(57) ABSTRACT

This is a method and apparatus for combined gravity separation-filtration for conducting physical, physical-chemical, chemical, and biological processes in solid-liquid systems; including but not limited to separation of dispersed solids from liquids, separation of alkalinity from the liquid stream, chemical acid-base interactions, chemical oxidation-reduction, chemical dissolution-precipitation, physical chemical adsorption, ion exchange, mass transfer in any combinations of multiple liquid-solid-gas phases, biological oxidation-reductions, biological growth, and combinations of these processes; gravity separation steps can be conducted in rectangular horizontal unidirectional flow clarifiers, rectangular or circular radial flow clarifiers, rectangular or circular vertical flow clarifiers, lamella clarifiers, suspended sludge blanket clarifiers, fluidized bed separators, and combinations thereof, wherein the filtration step is disposed in the upper portion of the combined process or side-by-side with clarification step; filtration steps are conducted in single or multiple attachment media filters, including particulate filter media either heavier than liquid or floating; liquid filtered through the attachment media is collected by holed pipes, screens, or membranes. Reagents can be introduced before the gravity separation and/or before filtration steps. This method and apparatus can be used for municipal and industrial water purification and wastewater treatment for removal of a broad range of admixtures including BOD/COD, suspended solids, nitrogen and phosphorus, organics imparting color, salts of hardness, heavy metals, and other constituents of admixture.

### RELATED APPLICATIONS

This is a Continuation in Part (CIP) of now allowed U.S. application Ser. No. 11/893,872.

### FIELD OF INVENTION

This is a method and apparatus for treatment of municipal and industrial water and wastewater in combined gravity separation-filtration process steps for conducting physical, physical-chemical, chemical and biological treatment processes.

### PRIOR ART

Water and wastewater treatment systems often include steps of gravity separation of suspended solids from water as a crude clarification step, followed by filtration for a thorough removal of the residual solids.

In typical water purification plants, the initial treatment is conducted by coagulating and flocculating the suspended particles in the influent followed by the crude gravity separation of the formed flocks in gravity separators or clarifiers of one or another kind. These flocks also adsorb at least a portion of he dissolved solids, for example humic and fulvic acids. In the subsequent filtration step conducted in a separate unit (or set of units), a thorough removal of the residual suspension is provided by using an attachment media of one or another kind. Some water purification plants are making use of membrane filtration also provided in a separate unit (or set of units). The systems with separate units are expensive because they require larger territories, larger buildings, complex flow distribution piping and flumes, many fittings, valves and gates, and special equipment.

In typical wastewater treatment plants, the initial treatment is conducted by biological treatment followed by a gravity separation of the formed biological flocks in gravity separators or clarifiers of one or another kind. Most of the gravity separated material is recycled back to biological process step(s) as activated sludge, and a portion equal to the new biomass growth is wasted from the system. A tertiary treatment is often required for more thorough removal of suspended solids and nutrients. Filtration is a common tertiary treatment. It can be conducted in the deep bed media filters similar to water filters (at larger plants), or in continuous filters with moving bed of the attachment media, usually sand, that is usually regenerated by recycling the bed with water via airlifts to hydrocyclones. In this subsequent filtration step conducted in a separate unit (or set of units), a thorough removal of the residual suspension, and removal of some nitrogen and phosphorus attributable to suspended solids are provided by using an attachment media. Sometimes, a cloth filter (or set of filters) can be used for tertiary treatment. Wastewater treatment plants can also use membrane filters for tertiary treatment. Membrane filtration is also provided in a separate unit (or set of units). The systems with separate units are expensive because they require larger territories, larger buildings, complex flow distribution piping and flumes, many fittings, valves and gates, and special equipment. Cloth and membrane filters do not provide large volume and surface area for conducting many chemical, physical-chemical and biological reactions needed for controlling a broad range of constituents in the final treatment steps of the effluent.

### SUMMARY OF INVENTION

This is a method of combined sequential gravity separation-filtration treatment of a solids-liquid mixture for producing treated liquid, wherein gravity separation and filtration steps are conducted in a single volume, the mixture is fed in this volume as a single influent flow and undergoes at least partial clarification in the gravity separation step to produce clarified flow and separated solids. This clarified flow carries the balance of the solids and it is continuously becoming the filtration influent in the sequential step of filtration. The step of filtration is intercepting at least a portion of the balance of solids and is producing a filtration effluent that is evacuated from the combined sequential gravity separation-filtration as a single effluent flow. The transfer of the clarified flow from the gravity separation step to the filtration step is provided without separate collection and transfer of the clarified flow and without distribution of the transferred flow in the filtration step. This method has significant advantages over conventional separate clarifiers with collection of the clarified effluent flow, transfer by pipes and/or flumes of this flow into separate filters, distributing the incoming flow in the filter filled with an attachment medium, with the use of a system of perforated pipes, or more complex and expensive means, filtering and producing the final effluent. As follows from the description at the beginning of this paragraph, the new system can be accommodated in a single combined unit; accordingly, the capital costs will be reduced. The system can be used for upgrading existing clarifiers. The hydraulic loading rate per unit surface of clarifiers is several-fold less than that for filters. Accordingly, filtration sections, or units, or modules can be installed within existing clarifiers. This method can also be easily accommodated in new designs. Considering that the operation of such systems is simpler than conventional systems, there will also be operational savings.

The solids-liquid mixture can be water, surface water, underground water, brackish water, swamp water, process water, recycled process water, recycled cooling water, industrial water, wastewater, municipal wastewater, sanitary wastewater, sewage, industrial wastewater, mixed liquor in biological wastewater treatment systems, farm wastewater, animal farm wastewater, solid waste landfill leachate, and other similar streams. The solids present in the mixtures can be mineral solids, organic solids, biological solids, biomass, activated sludge, biofilm, solids formed from dissolved substances in the influent flows and from the added reagents during separation and filtration steps, solids formed with added mineral coagulants, solids formed with added organic coagulants, solids formed with added mineral polymers, solids added with added organic polymers, solids formed through biological processes in said filtration step, solids chemically precipitated during said separation and filtration steps, solids forming insoluble constituents during said separation and filtration steps, flocculent solids, crystalline solids, and combinations thereof.

The sequential gravity separation-filtration steps can be arranged vertically, horizontally, and as combinations thereof.

The gravity separation of said solids from said liquid can be conducted in a new circular clarifier, an upgraded circular clarifier, a new square clarifier, an upgraded square clarifier, a new rectangular clarifier, an upgraded rectangular clarifier, a new polygonal clarifier, an upgraded polygonal clarifier, a new clarifier with peripheral feed, an upgraded clarifier with peripheral feed, a new clarifier with central feed, an upgraded clarifier with central feed, a clarifier with predominantly upward flow of said mixture, a clarifier with predominantly plain-parallel horizontal flow of said mixture, a clarifier with predominantly radial flow of said mixture, a clarifier with lamella plates, a tubular clarifier, a clarifier with a suspended sludge blanket, and combinations thereof.

The step of filtration can include horizontal flow filtration, vertical flow filtration from the top down, vertical flow filtration from the bottom up, radial-essentially-horizontal flow filtration, dual flow filtration, and combinations thereof.

The backwash step in filtration part of the process is provided for dislodging the intercepted solids in the filtration step. The backwash can be a continuous backwash, a periodic backwash, a backwash with interruption of filtration step, a backwash without interruption of filtration step, backwash with a separate backwash zone for uninterruptable filtration, backwash with membrane media for uninterruptible filtration step and for thorough filtration, backwash with water, backwash with air, backwash with water saturated with air, backwash with water carrying oxidizers, backwash with water carrying reducing agents, backwash with water carrying acids, backwash with water carrying alkali, backwash with water carrying solvents, backwash with water carrying reagents for producing soluble complexes, and combinations thereof.

The method further provides at least one step of modification of the solid-liquid mixture. The modifications are applying mechanical actions, physical-chemical actions, chemical modification, biological modification, and combinations thereof. The mechanical action can be applied in combination with the gravity separation step, and in combination with filtration step. These mechanical actions can include mixing, vibration, internal recirculation with or without baffles, gas feeding, air feeding, non-uniform feeding of a gas, non-uniform feeding of air, feeding of gas-saturated water, non-uniform feeding of gas-saturated water, mixing with the use of static baffles and combinations thereof.

The physical-chemical actions can be applied in combination with the gravity separation step, and in combination with the filtration step and can include applying magnetic fields, electromagnetic fields, piezoelectric actions, adsorption, adsorption on powdered activated carbon, adsorption on powdered coal, mass transfer of gases, mass transfer of oxygen, mass transfer of carbon dioxide, and combinations thereof.

The step of chemical modification can be provided for feeding reagents prior to said clarification step, feeding reagents prior to said filtration step, feeding reagents in combination with backwash step, feeding reagents for acid-base control, feeding reagents for oxidation-reduction control, feeding reagents for dissolution-precipitation control, feeding water containing at least one alkali, feeding water containing sodium hydroxide, feeding water containing calcium hydroxide, feeding water containing magnesium hydroxide, feeding water containing at least one acid, feeding water containing hydrochloric acid, feeding water containing sulfuric acid, feeding water saturated with air-oxygen mixture with oxygen content in the mixture from 20 to 100%, feeding water with a dissolved oxidizer, feeding water with dissolved ozone, feeding water with dissolved active chlorine, feeding water with dissolved permanganate, feeding water with dissolved ferric ions, feeding water with dissolved reducing agents, feeding water with solution of sulfur dioxide, feeding water with solution of ferrous ions, feeding water with precipitating reagents, feeding water with multivalent metals, feeding water with ferrous iron salts, feeding water with aluminum salts, feeding water with calcium salts, feeding water with magnesium salts, and combinations thereof.

The biological modification can be biological oxidation, biological reduction, removal of BOD, removal of COD, removal of organic carbon, removal of ammonia, biological reduction, removal of nitrates, removal of nitrites, biological coagulation of particles, biological growth of filtration film on the surface of membrane media in the filtration step, and combination thereof.

The gravity separated solids and said backwash solids can be collected via collecting separated solids and backwashed solids together, segregated collecting of separated solids and backwashed solids, and partially segregated collecting of separated and backwashed solids.

At least one step of evacuating the gravity separated and collected solids and the collected backwash solids can include evacuating of collected-separated solids and collected-backwashed solids together, segregated evacuating of collected-separated solids and collected-backwashed solids, and a partially segregated evacuating of collected-separated and collected-backwashed solids.

This is also an apparatus for conducting the method of the present invention comprising
a clarifier provided with a complete enclosure and means for distributing influent,
at least one filtration module built-in the clarifier and provided with an incomplete enclosure in hydraulic communication with the clarifier, the filtration module having an attachment medium and means for collecting filtrate, whereby the filtration module and the clarifier are in continuous hydraulic communication, and whereby the continuous communication is provided without means for collecting clarified liquid and without means for distributing the filter influent.

This apparatus can include a new circular clarifier, an upgraded circular clarifier, a new square clarifier, an upgraded square clarifier, a new rectangular clarifier, an upgraded rectangular clarifier, a new polygonal clarifier, an upgraded polygonal clarifier, a new clarifier with peripheral feed, an upgraded clarifier with peripheral feed, a new clarifier with central feed, an upgraded clarifier with central feed, a converted clarifier with a central feed into a clarifier with a peripheral feed, a clarifier with predominantly upward flow of said mixture, a clarifier with predominantly plain-parallel horizontal flow of said mixture, a clarifier with predominantly radial flow of said mixture, a clarifier with lamella plates, a tubular clarifier, a clarifier with a suspended sludge blanket, and combinations thereof.

In this apparatus, the clarifier is provided with a clarification zone, and further, with a filtration module in a side-by-side position of the clarification zone and the filtration module, or a stacked position of the filtration module above the clarification zone.

The filtration module can be an essentially horizontal flow filtration module, essentially vertical flow filtration module from the top down, essentially vertical flow filtration module from the bottom up, essentially radial flow filtration module, dual-flow filtration module, and combinations thereof.

The attachment media in the filtration module can be a single medium, a multiple media, stratified media, mixed media, at least one medium heavier than said liquid, at least one floating medium, at least one mineral medium, at least one synthetic medium, at least one granular medium, at least one fuzzy medium, at least one structured medium, at least one flexible medium, a structured netting flexible media, a structured netting rigid media, a structured rigid media, pall rings, plastic beads, plastic shapes, holed plastic shapes, ribbed plastic shapes, and combinations thereof.

The filtrate collecting means can be open flow troughs with side overflow, open flow flumes with side overflow, perforated pipes, slotted pipes, porous pipes, pipes with cloth sheath, pipes with netting sheath, pipes with screening sheath, membranes, microfiltration membranes, ultrafiltration membranes, nanofiltration membranes, flat membranes, spiral wound membranes, hollow fiber membranes, membranes made of polymeric materials, ceramic membranes, means for collecting filtrate located at the same elevation, multiple means for collecting filtrate located at different elevations, and combinations thereof.

The filtration surface of membranes can be either in contact with the attachment media or without contact with the attachment media. For example, if flat membranes are placed at a tight spacing narrower than the size of the attachment media (e.g. size of filtration media beads or grains) the membrane surface cannot be mechanically cleaned by the media (e.g. during backwash), however, at a larger spacing of membranes, the attachment media (e.g. beads) can gently scrub the membrane surface and additionally regenerate it for maintaining the improved filtration.

During very high influent flows, means for at least partially by-passing the filtration module can be provided. The filtration modules may be by-passed completely or they can be operated at a nominal capacity during the maximum influent flows, with the difference between the maximum influent and the nominal filters flow is by-passing the filters.

The filtration module can be arranged for backwashing as a single filtration-backwash section, or as separate filtration and backwash sections, these separate section may have or may not have a physical barrier (a wall). When a wall is not used, the border between the sections may be fuzzy.

The filtration module can be either fixed or floating within the clarifier.

The clarifier can be provided with lamella section. At least in part, the lamella section can constitute the incomplete enclosure of the filtration module.

The present method and apparatus can be used in systems for mechanical (separation of solids from liquid), physical-chemical, chemical, and biological treatment processes. In biological treatment, this method and apparatus will usually, but not exclusively, represent the tertiary treatment. Relevant biological systems can include conventional plants, advanced plants with nutrients removal and thorough treatment of wastewater plants with sludge and energy reductions. Biological reactors used in these systems may be suspended sludge growth reactors, attached growth reactors, reactors with various flow patterns, reactors in the range from pure oxygen systems to strongly anaerobic systems. In water purification systems, this method and apparatus can often be used as the total treatment plant because it includes all major treatment steps and can be accommodated with built-in steps for rapid mixing of reagents.

The present designs of membrane bioreactor plants can be beneficially modified in view of the present invention. The main claimed advantages of membranes submerged into biological reactors are (1) ability to increase the concentration of biomass to 8 to 12 g/l, and (2) the ability to reduce the suspended solids in the effluent to less than 1 mg/l, while fractions of nitrogen and phosphorus associated with suspended solids are virtually eliminated from the effluent. Considering that the present day biological processes with conventional clarifiers, for example sludge and energy reduction Catabol process by Khudenko Engineering Inc., can reliably maintain the activated sludge concentration in bioreactors at 8-12 g/l, and sometimes at 15 g/l or greater, the first function of membranes becomes completely redundant. Moreover, operation of membranes in bioreactors is problematic due to perpetual plugging of membranes, and foam, scum and crud formation in bioreactors, and humongous energy demand for the ongoing membrane cleaning. Upgrading of the existing secondary treatment plants with membranes should preferably make use of the filtration modules of the present invention with or without membranes placed into existing clarifiers. The existing clarifiers can be modified as described in the present specification.

### DRAWINGS

FIG. 1 is a vertical section of a combination of a clarifier with vertical flow of solid-liquid mixture and a single-section filtration modules built-in the clarifier above the clarification zone.

FIG. 2 is a vertical section of a continuously operated filtration module divided into filtration and bed regeneration sections.

FIG. 3 is a vertical section of a side-by-side clarification zone consisting of a plurality of lamellas and of a filtration module with the partial enclosure formed by the plurality of lamellas; this embodiment is with the separate sludge collection from clarification and filtration zones.

FIG. 4 is a vertical section of a combination of a suspended sludge blanket clarifier and a filtration module built-in the sludge separation zone of the clarifier.

FIG. 5 is a vertical section of a combination of an upgraded radial-flow circular clarifier and built-in filtration modules stacked above the clarification zone, the upgraded clarifier is converted into clarifier with the peripheral influent feed and the central removal of filtrate.

FIG. 6 is a section of the upper portion of the combined clarification-filtration apparatus showing multiple means for collecting effluent positioned at different elevations.

### DESCRIPTION OF EMBODIMENTS

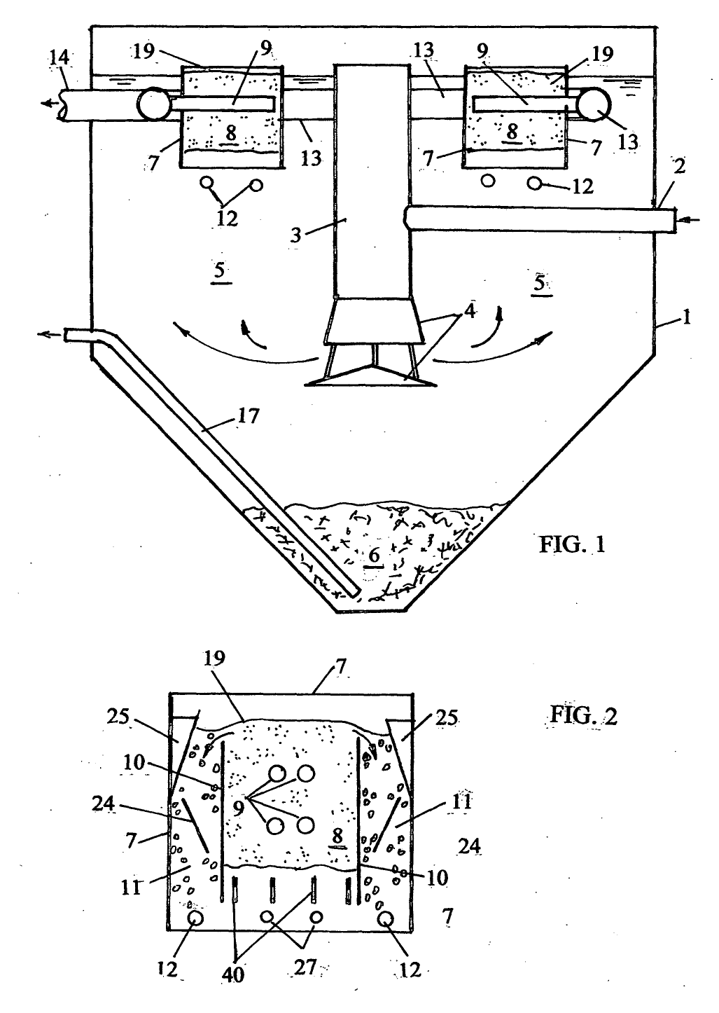

FIG. 1 is a vertical section of a combination of a clarifier 1 with vertical flow of solid-liquid mixture and a single-section filtration modules 19 built-in the clarifier above the clarification zone 5. One or several filtration modules 19 can be installed in the upper section of the clarification zone 5. Each filtration module 19 is enclosed by side walls 7 and has open top and bottom, therefore, the clarification zone 5 is in direct communication with the filtration zone 8. A feed pipe 2 for the influent solid liquid mixture is connected to a feed well 3 with a flow distributor 4 submerged at the lower level of the clarification zone 5. After the flow distributor 4, the influent flow rises through the clarification zone 5, the suspended solids heavier than water are settling down across zone 5 and become collected in sludge zone 6, from where the sludge is evacuated by a line 17. At least partially clarified solid-liquid mixture enters the filtration modules 19 from the open bottom and passes through a floating bed 8, which is also the filtration zone. Additional quantity of solids carried by partially clarified stream of solid-liquid mixture is intercepted and retained in the filtration bed 8 on the surface of the bed media, e.g. floating plastic beads. Filtrate is collected by means 9, this means can be porous, or holed pipe or an assembly of membranes of one or another kind as described in section “Summary of Invention”. The holes must be smaller than the beads of the filter bed. Filtrate collection means are connected to the evacuation manifold 13 and further to the discharge conduit 14 for the treated effluent.

The intercepted solids are dislodged, or backwashed, from the filter bed 8 by compressed air fed via lines 12, for example holed, or porous pipes similarly to aeration processes. Alternatively, gas-saturated water can be delivered through lines 12. This is similar to feeding the floatation stream saturated with a gas. When this stream is released from the distribution means 12, dissolved gas gets released in form of small bubbles. Air or other gas, or mixture of gases can be used. Gas-saturated water is easier to distribute uniformly than gas alone, which is an advantage of such a backwash over supplying backwash water and backwash air via separate distribution piping. Another advantage is that the gas-saturated backwash water can be easily pulsed, for example by using ON/OFF or flow control valve on the feed line to the means 9. Another option is to feed intermittently water, gas-saturated water, or gas through the means 9. Additionally, soluble, including gases, or dispersed regents can be added to the water used in preparation of the gas-saturated stream. Only gaseous reagents can be added to air. In this embodiment when provided with holed pipes 9 for filtrate collection, only periodic backwash can be done. In such a case, backwash is performed only while interrupting the filtration step, for example by closing a valve on the respective part of the manifold 13 (valve is not shown). In case of using membranes as means 9 for collecting filtrate (and for additional treatment), the backwash can be done without interrupting the operation of the filtration module because membranes will intercept the solids being detached from the bed 8 media and stirred up around the filtrate collector. The backwashed solids join the downward flux of the solids in the gravity separation zone 5.

FIG. 2 is a vertical section of a continuously operated and backwashed filtration module 19 divided into filtration 8 and bed regeneration (or continuous, or semi-continuous backwash) 11 sections separated by baffles 10. The top and the lower edge of baffles 10 are respectively lower than the top and the bottom of the floating bed 8, this bed is made of the attachment media, for example, floating polyethylene beads, or other shapes as previously described. Air distribution pipes 12 (or alternatively, pipes for distribution of the gas-saturated water) are provided under sections 11. Optionally, sections 11 can be provided with static mixing baffles 24. Various designs of static mixing means can be used. Also optionally, floats 25 can be provided, for example inside sections 11 as shown in the FIG. 2. Also optionally, the floats 25 can be movable during the installation or service operations for adjusting the elevation of the floating version of modules 19. Section 8 contains filtrate collection means 9 selected as previously described. Reagent distribution means 17 are provided under the filtration zone 8. Elements 40 for restructuring water such as piezoelectric elements, or magnetic elements, constant or electromagnetic, are installed in the path of the flow entering the filtration bed 8.

The filtration module 19 of FIG. 2 is operated as follows. The partially clarified influent of the solid-liquid mixture enters the filtration zone 8 wherein most of the particles remaining in the solid-liquid mixture after gravity separation are intercepted by the filtration media. Air, or gas-saturated water, or air and water separately, are fed in the section, or sections, 11, thus lowering the effective density of contents in sections 11. At lower density, the water-floating media, for example made of polyethylene, overflows from the top of the filtration zone 8 into bed regeneration zones 11, wherein the media sinks down to the lower level of the aerated column in zone 11, and further goes to the bottom of section 8. The bed in section 8 is gradually moving upward and is recycled through the regeneration zones 11. The gas bubbles in zone 11 create turbulence that causes solids attached to and collected on the media surface to detach. Detached solids sink down and are removed from the filtration module 19. Static mixing means, such as baffles 24, increase the mixing and turbulence for more thorough detachment of solids from the bed media being regenerated. Pulsed or otherwise non-uniform feed of the backwash media, particularly gas, or gas-saturated water, causes the Archimedean flotation force to vary due to variations in the effective density of media inside sections 11 where the floats 25 are located. Alternating feed of backwash media in the left and in the right sections 11 can also be used. Accordingly, variable floatation forces can be applied to floating filtration module 19 thus forcing it to shake (or pulse) up and rock with alternating motion of the left and right sides of the filtration module up and down, such mechanical motions are improving the filtration media backwash in sections 11, and shaking the filtration media in section 8 for reducing the hydraulic resistance of the media and for improving the contact between particles of the solid-liquid mixture and the attachment media surface, and for increasing the rate of reactions between added reagents and the chemical and biological components of the attachment film on the surface of the attachment media. The backwash procedure and the control of processes on the surface of the attachment media described herein offers great advantages over conventional methods and apparatus.

Elements 40 for restructuring water such as piezoelectric elements, or magnetic elements, constant or electromagnetic, that are installed in the path of the flow entering the filtration bed 8, form modified “crystalline” structure of the water and cause many chemical and biological reactions to happen at an accelerated rate. The effects produced by elements capable of restructuring water had been used for removing salts causing hardness deposits, herein, these effects are employed for accelerated and more thorough removal of phosphates, and heavy metals. In the present invention, effects of restructuring water are combined with providing an optimal reagents, and more particularly, multiple reagents. For example, a combination of ions of iron, ferrous and/or ferric, aluminum, calcium, and magnesium results in improved rate and efficiency of phosphorus precipitation and in reduction of the reagent requirements (can be expressed in chemical equivalents) as compared to using any single reagent. Moreover, using combinations of these reagents broadens the range of pH for the efficient phosphorus removal. In cases of water restructuring, small crystals of precipitating salts are formed. Such small crystals do not gravity settle in water against even smallest turbulent wakes and behave as quasi-soluble particles. In the present invention, a portion of the reagent salts is used to form a film of metal hydroxides gel on the surface of the attachment media 8, thus improving the particle attachment and, therefore, removing microscopic “precipitated” (insoluble at the conditions of treatment, but very small) particles on the gel covered surface of the bed 8. This mechanism is effective for all embodiments described herein and for all embodiments claimed and designed by skilled in art as is taught in the present invention.

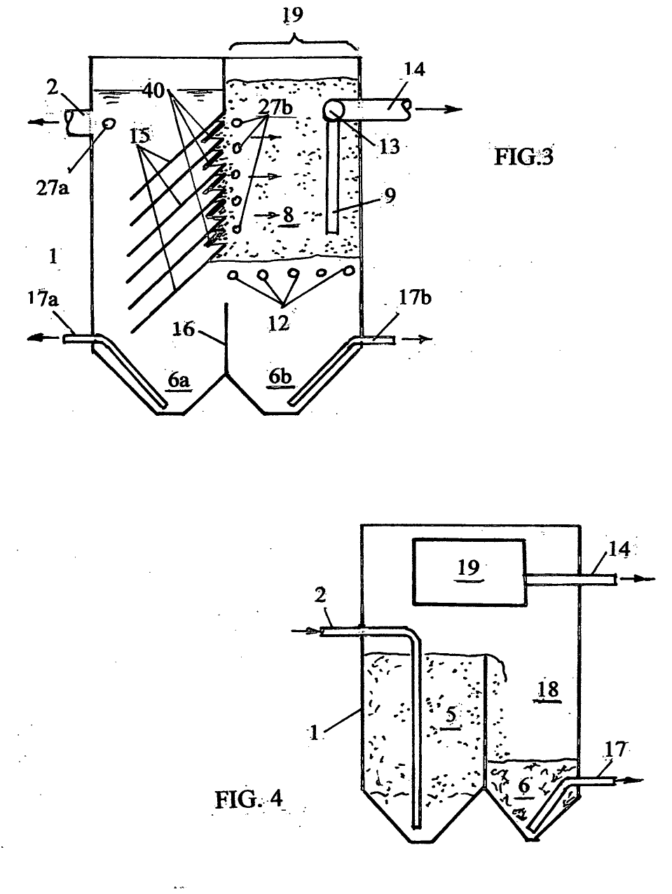

FIG. 3 is a vertical section of side-by-side clarification zone consisting of a plurality of lamellas 15 and of a filtration module 19 with the partial enclosure formed by the plurality of lamellas 15. A floating attachment media constitutes the filtration bed 8. Two sludge compartments 6a and 6b with a partition 16 provide segregated separation and collection of the gravity separated solids and of solids removed by filtration. Partition 16 can be provided in positions shifted either left or right from that shown in FIG. 3 so that partially segregated collection of these separated and filtered solids can be established. Segregated or partially segregated evacuation of these solids is provided by conduits 17a and 17b. The solid-liquid influent is fed via conduit 2, becomes distributed over lamellas 15, wherein solids are partially separated from the solid-liquid mixture, the solid-liquid mixture continuously enters the filtration zone 8, or bed, proceeds essentially horizontally, is collected as the filtered solid-liquid effluent by the filtrate collection means 9 connected to a manifold 13 and further to the discharge conduit 14. Any previously described collection means 9 can be used. The embodiment of FIG. 3 can be provided with the bed regeneration section(s) 11 as shown and described in FIG. 2. Depending on the type of means 9 the attachment media in bed 8 can be backwashed and regenerated as previously described. Reagents can be provided into the gravity separated zone via feed line 12a as shown, or connected to the feed line 2, and to the filtration zone via lines 12b. The reagent feed is provided via means 27a and 27b prior to clarification and filtration steps respectively. Reagent feed is as previously described. Elements 40 for restructuring water such as piezoelectric elements, or magnetic elements, constant or electromagnetic, are installed in the path of the flow, within lamellas 15, entering the filtration bed 8. These elements can be integrated with or into lamellas 15.

FIG. 4 is a vertical section of a combined apparatus 1 including a suspended sludge blanket clarifier 5 with a sludge decanting zone 18, and a filtration module 19 built-in the sludge separation zone of the clarifier. The solid-liquid mixture influent is fed via conduit 2 and passes upwardly across the suspended sludge zone 5 wherein a significant gravity clarification is achieved. Reagents can be added to the line 2 as previously described. Reagents, particularly coagulant salts and substances for pH-alkalinity control are specifically needed in water purification systems, such as in municipal and industrial water supplies. The fluidized flocculated solids accumulate in the gravity separation zone to a certain concentration that depends on the properties of flocks and on the upward velocity of the liquid. After that, solids are discharged from suspended sludge blanket zone 5 into sludge separation zone 19, accumulate at the bottom sludge zone 6, and are discharged via conduit 17. A filtration module 19 is provided above zones 5 and 18. The module 19 can have all previously described elements and provisions and can be operated as previously described. Skilled in art are familiar with operation of suspended sludge blanked apparatus.

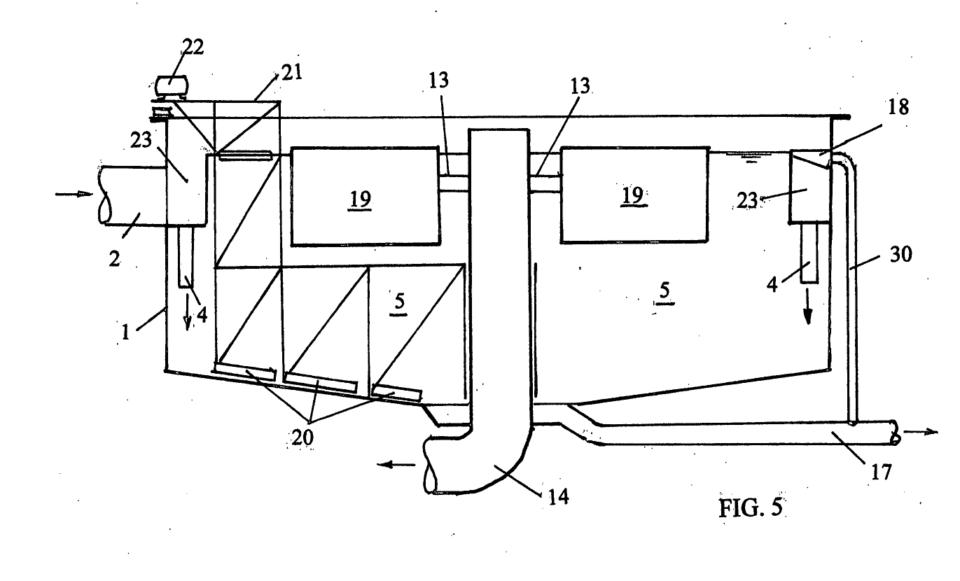

FIG. 5 is an upgraded radial-flow circular clarifier 1 and built-in filtration modules 19 submerged in the upper reaches of the clarification zone 5. The upgraded unit is converted into a clarifier with the peripheral influent feed and the central removal of filtrate: the conduit 2, that prior to upgrade was the effluent line, becomes the feed conduit, the peripheral through 23 that used to be the effluent collection through is converted into the influent distribution through and is provided with flow splitting down-corners 4, and the central pipe 14, that was the influent pipe prior to the upgrade, is extended upward and converted into the effluent pipe. Preferably floating filtration modules 19 are connected to the pipe 14 via flexible conduits 13 accommodating some vertical motion of the modules 19. The shape of the rotating frame 21 with scrapers 20 is modified to pass under the built-in filtration modules 19 and is provided with peripheral drive 22. As in the original design, scrapers 20 push the settled sludge along the bottom to the center of the clarifier wherein it is evacuated via conduit 17. Floating skimmings are collected into a bean 18 and are removed via line 30 together with the bottom sludge via line 17. The module 19 can have all previously described elements and provisions and can be operated as previously described. Skilled in art are familiar with operation of clarifiers with peripheral influent feed.

It is obvious that a secondary clarifier with central feed can be upgraded by installing filtration modules connected to the existing peripheral effluent collection trough.

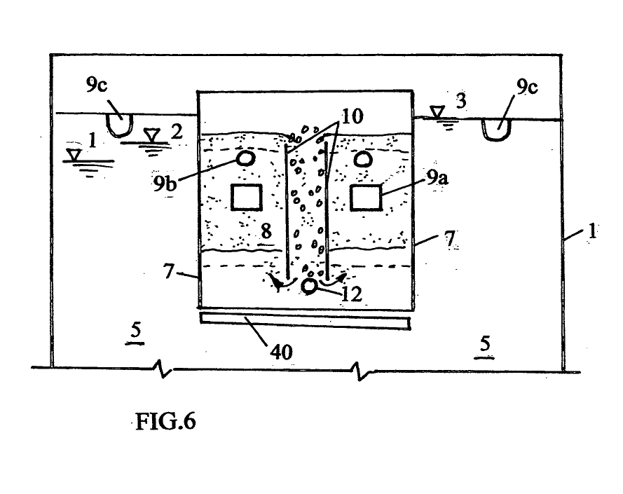

FIG. 6 is a section of the upper portion of the combined clarification-filtration apparatus 1 showing multiple means for collecting effluent positioned at different elevations. Other elements of the system had already been described and the descriptions will not be repeated here. This embodiment is advantageous in cases of very high range of flows, for example, significantly variable dry weather flows and significant influent increase during storm events. As an example, possible water elevations El 1, El 2, and El 3 can correspond to a certain probability percentile for dry influent flow (e.g. 80%), the maximum design dry weather flow (100%) and the maximum design wet weather flow (e.g. 25 years probable rain coinciding with the maximum dry weather flow for municipal influent). As an example, the lowest level effluent collection means 9a will be operated in the range of elevations from El 1 (or lower, but above the means 9a) to El 2. When the flow exceeds 80-percentile (or as otherwise selected), the next level collection means 9b becomes submerged and starts taking in the effluent, and yet at wet weather events and up to the selected rain flow probability means 9c becomes operable. Different means for collectors 9a, 9b, and 9c should be used. For example, collector 9a can include membranes, collector 9b can be made with holed pipes, and collector 9c may be an open flow trough, this trough can be positioned in the filtration module or beyond the filtration module at the top of the clarification zone. Such system of collecting effluent can be justified by the fact that the flow rates in the receiving streams during wet weather events is dramatically increased thus providing significant dilution of the effluent, accordingly, the requirements for the total effluent filtration can be reduced for the duration of the storm event.

Elements 40 for restructuring water such as piezoelectric elements, or magnetic elements, constant or electromagnetic, are installed in the path of the flow entering the filtration bed 8.

The invention described here presents significant advantages over the prior art. A simple and efficient upgrading of the secondary wastewater treatment to the tertiary treatment can be provided without expanding the plant (within existing tanks) by installing filtration modules, sometimes with simple additional modification of pipes and troughs. Water purification plants can also be upgraded and their capacity expanded by building filtration modules in existing clarifiers. New plants can be made more compact and more efficient.

The present combination of gravity separation and filtration is substantially simpler that the commonly used sequential secondary clarifiers and tertiary filters with periodic cycles of filtration-backwash or continuous filters with recycling of the sand bed. The present invention eliminates the need in separate treatment units for the secondary clarification and tertiary filtration, thus reducing the required territory, eliminating means for collecting and evacuating clarified effluent and means for distributing influent to the filters, both means would include expensive pipes, valves, gates, and special equipment. Filtration through attachment media with membranes also present important advantages over prior art.

Attachment media presents a significant advantage over membranes in the tertiary treatment and in water purification: attachment media provides surface and volume for conducting many reactions for removing admixtures to the water. Chemically and biologically active films are formed on the developed (large) surface of the attachment media. These films and many admixtures coming with the influent or chemically or biologically formed may accumulate with these films. The accumulated materials can be easily dislodges and removed, thus regenerating the attachment surface for the next period of use. As compared to the usual attachment media, membranes have a very small area, this area may have a very thin beneficial layer of chemical or biological deposits, however, it cannot accommodate precipitation of significant amounts of deposits as needed for the tertiary treatment, for example, for thorough removal of suspended solids and phosphorus. Precipitations of the salts of hardness add to the problem of membranes plugging. Accordingly, operating membranes without prior attachment media filtration becomes an operational problem that is well familiar and painful at numerous plants. The present invention combines the advantages of the attachment media and the membranes. The capital costs of membranes used in the new system is reduced as compared to the now-standard membrane bioreactors (MBR) because, at grossly reduced plugging, the area of membranes can be drastically reduced (by a factor of two to four). This would compensate for an additional cost of filtration through the attachment media. The operating costs would also be reduced as compared to MBR because there is no need in perpetual high aeration of the membrane surface, in frequent back-pulses, and relentless reagent (concentrated alkali and/or acid and large amounts of chlorination) treatment.

The present specification and claims provide skilled in art with the necessary instructions for designing the described embodiments modifications of invention for a broad range of applications. The description of all modifications is not possible (and not needed). Accordingly, embodiments that are designed based on the present teachings and modified within the scope of the present teachings should not be considered as new inventions even if they have some difference as compared to the present invention but do not present new features that would provide unexpected advantages.

1. A method of combined sequential gravity separation-filtration treatment of a solids-liquid mixture for producing treated liquid, wherein gravity separation and filtration steps are conducted in a single volume, said mixture is fed in said volume as a single influent flow, said mixture is at least partially clarified in said gravity separation step to produce clarified flow and separated solids, said clarified flow carrying the balance of said solids is continuously becoming the filtration influent in said sequential step of filtration, said step of filtration is intercepting at least a portion of said balance of solids and is producing a filtration effluent, and said filtration effluent is evacuated from said Combined sequential gravity separation-filtration as a single effluent flow, whereby the transfer of said clarified flow from said gravity separation step to said filtration step are provided without separate collection and transfer of said clarified flow and without distribution of the transferred flow in the filtration step.

2. The method of claim 1, wherein said solids-liquid mixture is selected from a group consisting of water, surface water, underground water, brackish water, swamp water, process water, recycled process water, recycled cooling water, industrial water, wastewater, municipal wastewater, sanitary wastewater, sewage, industrial wastewater, farm wastewater, animal farm wastewater, solid waste landfill leachate, and combinations thereof.

3. The method of claim 1, wherein said solids are selected from a group consisting of mineral solids, organic solids, biological solids, biomass, activated sludge, biofilm, solids formed during said separation and filtration steps, solids formed with added mineral coagulants, solids formed with added organic coagulants, solids formed with added mineral polymers, solids added with added organic polymers, solids formed through biological processes in said filtration step, solids chemically precipitated during said separation and filtration steps, solids forming insoluble constituents during said separation and filtration steps, flocculent solids, crystalline solids, and combinations thereof.

4. The method of claim 1, wherein said sequential gravity separation-filtration steps are selected from the group consisting of steps arranged vertically, steps arranged horizontally, and combinations thereof.

5. The method of claim 1, wherein said gravity separation of said solids from said liquid is conducted in a clarifier selected from the group consisting of a new circular clarifier, an upgraded circular clarifier, a new square clarifier, an upgraded square clarifier, a new rectangular clarifier, an upgraded rectangular clarifier, a new polygonal clarifier, an upgraded polygonal clarifier, a new clarifier with peripheral feed, an upgraded clarifier with peripheral feed, a new clarifier with central feed, an upgraded clarifier with central feed, a clarifier with predominantly upward flow of said mixture, a clarifier with predominantly plain-parallel horizontal flow of said mixture, a clarifier with predominantly radial flow of said mixture, a clarifier with lamella plates, a tubular clarifier, a clarifier with a suspended sludge blanket, and combinations thereof.

6. The method of claim 1, wherein said step of filtration is selected from a group consisting of horizontal flow filtration, vertical flow filtration from the top down, vertical flow filtration from the bottom up, radial-essentially-horizontal flow filtration, dual flow filtration, and combinations thereof.

7. The method of claim 1, wherein backwash step is provided, whereby dislodging said intercepted solids intercepted in said filtration step, and wherein said backwash is selected from a group consisting of continuous backwash, periodic backwash, backwash with interruption of filtration step, backwash without interruption of filtration step, backwash with a separate backwash zone for uninterruptable filtration, backwash with membrane media for uninterruptible filtration step and for thorough filtration, backwash with water, backwash with air, backwash with water saturated with air, backwash with water carrying oxidizers, backwash with water carrying reducing agents, backwash with water carrying acids, backwash with water carrying alkali, backwash with water carrying solvents, backwash with water carrying reagents for producing soluble complexes, and combinations thereof.

8. The method of claim 1 and further providing at least one step of modification of said solid-liquid mixture, said step of modification is selected from the group consisting of applying mechanical actions, physical-chemical actions, chemical modification, biological modification, and combinations thereof.

9. The method of claim 8, wherein said mechanical action is selected from the group consisting of applying said mechanical action in combination with said gravity separation step, applying said mechanical action mixing in combination with filtration step, vibration, internal recirculation, gas feeding, air feeding, non-uniform feeding of a gas, non-uniform feeding of air, feeding of gas saturated water, non-uniform feeding of gas saturated water, mixing with the use of static baffles, and combinations thereof.

10. The method of claim 8, wherein applying said physical-chemical actions are selected from the group consisting of applying said physical-chemical modifications in combination with said gravity separation step, applying said physical-chemical modifications in combination with said filtration step, applying magnetic fields, electromagnetic fields, piezoelectric actions, adsorption, adsorption on powdered activated carbon, adsorption on powdered coal, mass transfer of gases, mass transfer of oxygen, mass transfer of carbon dioxide, and combinations thereof.

11. The method of claim 8 wherein said chemical modification is selected from the group consisting of feeding reagents in combination with said clarification step, feeding reagents in combination with said filtration step, feeding reagents in combination with backwash step, feeding said reagents for acid-base control, feeding said reagents for oxidation-reduction control, feeding said reagents for dissolution-precipitation control, feeding water containing at least one alkali, feeding water containing sodium hydroxide, feeding water containing calcium hydroxide, feeding water containing magnesium hydroxide, feeding water containing at least one acid, feeding water containing hydrochloric acid, feeding water containing sulfuric acid, feeding water saturated with air-oxygen mixture with oxygen content in the mixture from 20 to 100%, feeding water with a dissolved oxidizer, feeding water with dissolved ozone, feeding water with dissolved active chlorine, feeding water with dissolved permanganate, feeding water with dissolved ferric ions, feeding water with dissolved reducing agents, feeding water with solution of sulfur dioxide, feeding water with solution of ferrous ions, feeding water with precipitating reagents, feeding water with multivalent metals, feeding water with ferrous iron salts, feeding water with aluminum salts, feeding water with calcium salts, feeding water with magnesium salts, feeding water with powdered activated carbon, feeding water with powdered coal, and combinations thereof.

12. The method of claim 8, wherein said biological modification is selected from a group of biological oxidation, biological reduction, removal of BOD, removal of COD, removal of organic carbon, removal of ammonia, removal of nitrates, removal of nitrites, biological coagulation of particles, biological growth of filtration film on the surface of membrane media in said filtration step, and combination thereof.

13. The method of claim 1 and further providing steps of collecting said gravity separated solids and said backwash solids, wherein said steps are selected from a group consisting of collecting said gravity separated solids and said backwashed solids together, segregated collecting said gravity separated solids and said backwashed solids, and partially segregated collecting said gravity separated and backwashed solids.

14. The method of claim 13 and further providing at least one step of evacuating said gravity separated and collected solids and said collected backwash solids, wherein said at least one step of evacuating is selected from a group consisting of evacuating said collected-separated solids and said collected-backwashed solids together, segregated evacuating said collected-separated solids and said collected-backwashed solids, and a partially segregated evacuating said collected-separated and said collected-backwashed solids.

15. An apparatus for conducting the method of claim 1 comprising
a clarifier provided with a complete enclosure and means for distributing influent,
at least one filtration module built-in said clarifier and provided with an incomplete enclosure in hydraulic communication with said clarifier, said filtration module having an attachment medium and means for collecting filtrate, whereby said filtration module and said clarifier are in continuous hydraulic communication, and whereby said continuous communication is provided without means for collecting clarified liquid and without means for distributing said filter influent.

16. The apparatus of claim 15 wherein said clarifier is selected from the group consisting of a new circular clarifier, an upgraded circular clarifier, a new square clarifier, an upgraded square clarifier, a new rectangular clarifier, an upgraded rectangular clarifier, a new polygonal clarifier, an upgraded polygonal clarifier, a new clarifier with peripheral feed, an upgraded clarifier with peripheral feed, a new clarifier with central feed, an upgraded clarifier with central feed, a converted clarifier with a central feed into a clarifier with a peripheral feed, a clarifier with predominantly upward flow of said mixture, a clarifier with predominantly plain-parallel horizontal flow of said mixture, a clarifier with predominantly radial flow of said mixture, a clarifier with lamella plates, a tubular clarifier, a clarifier with a suspended sludge blanket, and combinations thereof.

17. The apparatus of claim 15, wherein said clarifier is provided with a clarification zone and further providing said filtration module in a position relative to said clarification zone selected from the group consisting of side-by-side position of said clarification zone and said filtration module, position of said filtration module above said clarification zone.

18. The apparatus of claim 15, wherein said filtration module is selected from a group consisting of essentially horizontal flow filtration module, essentially vertical flow filtration module from the top down, essentially vertical flow filtration module from the bottom up, essentially radial flow filtration module, dual flow filtration module, and combinations thereof.

19. The method of claim 15, wherein said attachment media is selected from a group consisting of a single medium, a multiple media, stratified media, mixed media, at least one medium heavier than said liquid, at least one floating medium, at least one mineral medium, at least one synthetic medium, at least one granular medium, at least one fuzzy medium, at least one structured medium, at least one flexible medium, a structured netting flexible media, a structured netting rigid media, a structured rigid media, pall rings, plastic beads, plastic shapes, holed plastic shapes, ribbed plastic shapes, and combinations thereof.

20. The apparatus of claim 15, wherein means for collecting filtrate are selected from the group consisting of open flow troughs, open flow flumes, perforated pipes, slotted pipes, porous pipes, pipes with cloth sheath, pipes with netting sheath, pipes with screening sheath, membranes, microfiltration membranes, ultrafiltration membranes, nanofiltration membranes, flat membranes, spiral wound membranes, hollow fiber membranes, membranes made of polymeric materials, ceramic membranes, means for collecting filtrate located at the same elevation, multiple means for collecting filtrate located at different elevations, and combinations thereof.

21. The apparatus of claim 20, wherein said membranes have filtration surface and are further selected from the group of membranes wherein said filtration surface is without direct mechanical contact with at least one said filtration medium, whereby said filtration media protects said filtration surface from plugging, and membranes wherein said surface is in contact with said filtration media, whereby the membrane surface is protected from plugging and cleaned during backwash.

22. The apparatus of claim 15 and further providing means for at least partially by-passing said filtration module.

23. The apparatus of claim 15, wherein said filtration module is selected from the group consisting of a filtration module with single filtration-backwash section, and filtration module with separate filtration section and backwash section.

24. The apparatus of claim 15 wherein said filtration module is selected from the group consisting of fixed filtration module, and floating filtration module.

25. The apparatus of claim 15, wherein said clarifier is provided with lamella section and, at least in part, said incomplete enclosure of said filtration module is provided by said lamella section.
